(19) United States
(12) Patent Application Publication
(10) Pub. No.: US 2007/0264457 A1
(43) Pub. Date: Nov. 15, 2007

(54) Material for Decoration

(75) Inventors: Takeshi Matsushita, Saitama (JP); Keiko Kitamura, Saitama (JP); Shuji Kota, Saitama (JP)

Correspondence Address: BACON & THOMAS, PLLC, 625 SLATERS LANE, FOURTH FLOOR, ALEXANDRIA, VA, 22314, US

(73) Assignee: KIMOTO CO., LTD., Tokyo (JP)

(21) Appl. No.: 11/660,662

(22) PCT Filed: Aug. 25, 2005
(86) PCT No.: PCT/JP05/15446

§ 371 Date: Feb. 21, 2007

(30) Foreign Application Priority Data
Aug. 26, 2004 (JP) 2004-246302

(51) Int. Cl. B32B 9/00

(52) U.S. Cl. 428/41.6

(57) ABSTRACT

A decorating member exhibiting superior flexibility, which allows the member to follow an object having a three-dimensional shape such as a three-dimensionally curved surface, is provided.

The decorating member 5 of the present invention comprises a laminate 4 consisting of a color material layer 1 and an adhesive layer 2, and peelable substrates 31 and 32 provided on the color material layer 1 and/or the adhesive layer 2, the laminate has a tensile yield strength of 1 to 12 MPa according to JIS K7113:1995, and the laminate can be elongated at an elongation rate of 100% or more with a tensile stress of 13 MPa or lower. The laminate 4 preferably has a re-peelable property and a re-adherable property.

### TECHNICAL FIELD

The present invention relates to a technique for decorating toys or models of automobiles, airplanes etc. by adhesion on the surfaces thereof, in particular, a technique for decorating objects having a three-dimensional shape such as a three-dimensionally curved surface.

### BACKGROUND ART

For coloring surfaces of toys or models of automobiles, airplanes etc., paints are conventionally applied directly by using a painting brush, writing brush or the like, or by using a spray. However, when a paint is applied with a painting brush or the like, unevenness of the coated thickness is likely to occur, and color may change depending on the thickness. Therefore, there is a problem that fineness of the finished surface may vary depending on workers. When a paint is applied with a spray, although unevenness of the coated thickness is unlikely to occur, the paint is scattered during spraying, and therefore a large working area is required. Moreover, in both cases, equipments for drying the paint are required, and they invite increase of cost of products. Furthermore, since the painted articles cannot be touched until the paint dries, there is also a problem of bad workability.

Further, when such models are decorated by drawing pictures, characters, patterns etc. on the surfaces thereof, it is troublesome to draw each of the figures one by one by using a writing brush or the like, and it is difficult to make them in the same finished styles. Therefore, adhesion of seals, marking films or the like on which pictures, characters, patterns etc. are drawn beforehand, has also been used. However, such seals or marking films have a problem that it is difficult to adhere them on a three-dimensional shape such as a three-dimensionally curved surface, although they can be adhered on an object having good flatness without problem.

Meanwhile, as a sheet for decoration, a sheet comprising an ethylene/(meth)acrylate copolymer as a substrate and an adhesive layer provided on the whole surface of the substrate is proposed in Patent document 1. Patent document 1: Japanese Patent Unexamined Publication (Kokai) No. 2002-294181

### DISCLOSURE OF THE INVENTION

### Object to be Achieved by the Invention

Therefore, an object of the present invention is to provide a material for decoration (decorating member) having superior flexibility following even an object having a three-dimensional shape such as a three-dimensionally curved surface.

### Means for Achieving the Object

The decorating member of the present invention comprises a laminate consisting of a color material layer and an adhesive layer, and a peelable substrate on the color material layer and/or the adhesive layer, wherein the laminate has a tensile yield strength of 1 to 12 MPa according to JIS K7113:1995, and a tensile stress of 13 MPa or lower required for elongating the laminate to an elongation rate of 100% or more.

The laminate preferably has a re-peelable property.

The laminate preferably has a re-adherable property.

The laminate preferably has a 180° peel adhesion of 0.01 to 4 N/10 mm according to JIS Z0237:2000.

The color material layer preferably comprises a vinyl chloride type resin.

The vinyl chloride type resin is preferably a vinyl chloride/vinyl acetate copolymer.

The color material layer preferably comprises a rubber type resin.

The color material layer preferably comprises nitrocellulose and a rubber type resin.

The rubber type resin is preferably an ethylene/vinyl acetate rubber or an acrylonitrile/butadiene rubber.

The laminate preferably has an anti-blocking layer contacting with the color material layer.

The anti-blocking layer preferably comprises a cellulose type resin. The surface of the anti-blocking layer preferably has a specular gloss (at incidence angle of 60°) of 110% or higher according to JIS K5600-4-7:1999.

The decorating member preferably comprises a layer containing a cellulose type resin between the color material layer and the substrate.

### Effect of the Invention

With the decorating member of the present invention, toys or models of automobiles, airplanes etc., even those having a three-dimensional shape such as a three-dimensionally curved surface, can be easily and finely decorated without using a paint.

### BEST MODE FOR CARRYING OUT THE INVENTION

Hereafter, embodiments of the decorating member of the present invention will be explained.

FIGS. 1 to 3 show embodiments of the decorating member of the present invention. As shown in the drawings, the decorating member 5 of the present invention comprises a laminate 4 consisting of a color material layer 1 and an adhesive layer 2, and peelable substrates 31 and/or 32 on one or both surfaces of the laminate 4. The peelable substrates 31 and/or 32 serves as a support of the laminate 4 consisting of the color material layer 1 and the adhesive layer 2, and when the laminate 4 is adhered on an object of decoration, the substrates 31 and 32 are peeled from the color material layer 1 and the adhesive layer 2, and finally thrown away.

The laminate 4 is adhered on an object of decoration, and because the physical properties thereof are defined to be within specific ranges, it can be a decorating member having superior flexibility, which allows the laminate to follow even a three-dimensional shape such as a three-dimensionally curved surface. Specifically, the laminate 4 has a tensile yield strength of 1 to 12 MPa, preferably 5 to 9 MPa, according to JIS K7113:1995, and the laminate can be elongated at an elongation rate of 100% or more, preferably 150% or more, with a tensile stress of 13 MPa or lower.

Because the laminate has a tensile yield strength of 1 MPa or higher, the plasticity of the laminate from which the substrate has been peeled does not become unduly high, and favorable handling property and workability thereof can be obtained when it is adhered to an object of decoration. Moreover, favorable re-peelable property can be obtained when the laminate is peeled from an object of decoration. Further, because the tensile yield strength is defined to be 12 MPa or lower, it has favorable plasticity, thus it can follow an object having a three-dimensional shape such as a three-dimensionally curved surface, and it becomes easer to adhere it on such an object. That is, favorable adhesion property for adhesion to an object of decoration can be obtained.

Further, because the tensile stress required for obtaining an elongation rate of the laminate of 100% or more is defined to be 13 MPa or lower, a strong force is not required for the laminate to make it follow a three-dimensional shape such as a three-dimensionally curved surface, when it is adhered on such a shape, and favorable adhesion property can also be obtained.

The laminate of the decorating member of the present invention preferably has a re-peelable property. The re-peelable property refers to a property that after the laminate is once adhered to an object of decoration, it can be peeled with a small force without remaining adhesive (without leaving a part of the adhesion layer on the object on which the laminate was adhered) . Although this property depends on the properties of the material constituting the adhesion layer, the laminate is also required to have a tensile yield strength of 1 MPa or higher, preferably 5 MPa or higher, according to JIS K7113:1995, as a physical property of the laminate. For example, when the adhered laminate shift from a position on which the laminate should be adhered, the laminate can be easily removed from the object of decoration, because the laminate has the re-peelable property. Therefore, erroneously decorated objects need not be thrown away, and thus the yield of the objects of decoration can be improved. Moreover, when the decorated object is thrown away, the laminate can be easily separated.

Further, the laminate preferably has re-adherable property for adhesion to an object of decoration. The re-adherable property means a property that after peeling of the adhered laminate, the laminate can be adhered again. Although the re-adherable property also depends on the properties of the material constituting the adhesive layer, the laminate desirably has a tensile yield strength of 5 to 9 MPa according to JIS K7113:1995, and the laminate can be elongated at an elongation rate of 100% or more desirably with a tensile stress of 13 MPa or lower, as physical properties of the laminate. For example, when the adhered laminate shift from a position on which the laminate should be adhered as mentioned above, the laminate can be removed from the object of decoration, and adhered again on a correct position, because the laminate has the re-adherable property, and therefore it is economically advantageous.

Moreover, the laminate of the decorating member of the present invention preferably has a 180° peel adhesion according to JIS Z0237:2000 of 0.01 to 4 N/10 mm, more preferably 0.05 to 3 N/10 mm. When the 180° peel adhesion is 0.01 N110 mm or higher, the laminate can be adhered to an object of decoration, and when it is 4 N/10 mm or lower, favorable re-peelable property can be obtained.

Hereafter, embodiments of each components will be explained.

The substrates 31 and 32 are thrown away after peeling from the laminate 4 as described above, and the material thereof is not particularly limited. For example, paper, synthetic paper, polyethylene laminated paper, plastic film, and so forth can be used, and examples of the plastic film include, for example, those of polyester, polycarbonate, polypropylene, polyethylene, polyallylate, acrylic resin, acetyl cellulose, polyamide, polyimide, polyvinyl chloride, vinylidene chloride/vinyl chloride copolymer, and so forth.

In order to improve the peelable property of the substrates 31 and 32 for peeling from the color material layer 1 and the adhesive layer 2, the substrates may be subjected to a release treatment by applying polyethylene wax or a silicone release agent to the surface contacting with the color material layer 1 or the adhesive layer 2.

The peelable substrate 31 contacting with the color material layer 1 can transfer the surface profile of the surface contacting with the color material layer 1 to the surface of the color material layer 1, and a substrate having a matted surface profile may be used for the substrate. Examples of the substrate having a matted surface profile include, for example, the substrate 31 on which a matting layer comprising a synthetic resin and a matting agent is formed, the substrate 31 formed as a matted film by incorporating a matting agent into the substrate 31 itself, the substrate 31 on which a matted profile is formed by sandblasting, chemical treatment or the like, and so forth.

Although the thickness of the substrate 31 is not particularly limited, it is preferably about 5 to 250 μm, more preferably 10 to 100 μm, considering the peelable property for peeling from the coloring material layer 1 and the adhesive layer 2 and the handling property as the decorating member 5, and from the economical viewpoint taking the fact that it is ultimately thrown away into consideration.

Hereafter, the color material layer 1 will be explained. In the present invention, the color material layer does not necessarily mean a colored layer, but it is a layer for imparting color, pattern, gloss or feeling of material such as unevenness to an object of decoration. So long as it has a property for imparting such items as mentioned above, it may consist of a single layer or multiple layers. For example, when an object of decoration is to be colored, the color material layer 1 is formed from a synthetic resin and a colorant, and when a pattern is imparted to an object of decoration, the color material layer 1 is formed by printing a desired pattern with a commercially available paint on a transparent layer formed from a synthetic resin. When the peelable substrate 31 is provided on the color material layer 1, the substrate 31 may be provided on the color material layer 1 on which printing was performed beforehand, or after the preparation of the decorating member 5, the peelable substrate 31 may be peeled, and then printing may be performed on the color material layer 1. Examples of the printing method include the conventionally known printing methods such as offset printing, silk screen printing, and gravure printing.

Moreover, if an ink receiving layer is provided on the color material layer 1, or a synthetic resin suitable for ink-jet printing is used for the color material layer 1, it becomes possible to easily print a desired pattern by using a commercially available ink-jet printer, as an alternative of the printing utilizing a commercially available paint.

When gloss is imparted to an object of decoration, the color material layer 1 may be formed from a synthetic resin without incorporating a colorant, or when both gloss and color are imparted, the color material layer 1 may be formed by laminating a transparent layer formed from a synthetic resin and a layer comprising a synthetic resin and a colorant.

By suitably choosing a synthetic resin or mixing synthetic resins as a material constituting the color material layer 1, the tensile yield strength according to JIS K7113:1995 and the tensile stress required to obtain an elongation rate of 100% or more of the laminate can be adjusted to be 1 to 12 MPa and 13 MPa or lower, respectively, as the properties of the laminate 4 consisting of the adhesive layer 2 and the color material layer 1.

Examples of the synthetic resin include, for example, resins having flexibility such as vinyl chloride type resins, vinylidene chloride type resins, vinyl acetate type resins, rubber type resins, urethane type resins, and acrylic resins, and resins containing vinyl chloride type resins are preferred, because such resins show favorable plasticity, follow even an article having a three-dimensional shape such as a three-dimensionally curved surface, and make adhesion easier. One or more kinds of these synthetic resins may be used as a mixture. Examples of the most preferred mixture system include mixture systems of a vinyl chloride type resin and a rubber type resin, and mixture systems of a rubber type resin and nitrocellulose.

Examples of the vinyl chloride type resins include vinyl chloride resins, vinyl chloride/vinyl acetate copolymers, vinyl chloride/acrylate copolymers, vinyl chloride/vinylidene chloride copolymers, vinyl chloride/vinyl acetate/maleic acid terpolymers, and so forth, and vinyl chloride/vinyl acetate copolymers are preferably used, if handling properties such as solubility and compatibility with other resins are taken into consideration.

The polymerization ratio of vinyl chloride and vinyl acetate in the vinyl chloride/vinyl acetate copolymers cannot be generally defined, because it may vary in the cases where the vinyl chloride/vinyl acetate copolymers are solely used, and they are used as mixtures with other resins such as rubber type resins. However, it may be about 95:5 to 30:70, preferably about 90:10 to 50:50. With a polymerization ratio within such a range, the color material layer exhibiting superior flexibility can be obtained, and the decorating member which follows a three-dimensional shape such as a three-dimensionally curved surface can be obtained.

Examples of the rubber type resins include acrylonitrile/butadiene rubbers, acrylic rubbers, polyurethane rubbers, butadiene rubbers, polyisoprene rubbers, styrene/butadiene rubbers, carboxyl group-containing acrylonitrile/butadiene rubbers, isobutylene/isoprene rubbers, ethylene/vinyl acetate rubbers, ethylene/acrylate rubbers, chlorinated polyethylene rubbers, chlorosulfonated polyethylene rubbers, hydrogenated acrylonitrile/butadiene rubbers, polychloroprene rubbers, ethylene/propylene rubbers, silicone rubbers, natural rubbers, various thermoplastic elastomers, and so forth, and one or more kinds of these can be used. When a mixture system of a vinyl chloride type resin and a rubber type resin is used, acrylonitrile/butadiene rubbers and styrene/butadiene rubbers are preferred in view of compatibility with vinyl chloride type resins.

The mixing ratio of a vinyl chloride type resin and a rubber type resin in a mixture system of the vinyl chloride type resin and the rubber type resin cannot be generally defined, because it may vary depending on types of the vinyl chloride type resin and the rubber type resin. However, for example, when a vinyl chloride resin is used as the vinyl chloride type resin, and an acrylonitrile/butadiene rubber is used as the rubber type resin, the weight ratio of vinyl chloride resin and acrylonitrile/butadiene rubber is preferably about 95:5 to 10:90. With a ratio of vinyl chloride resin and acrylonitrile/butadiene rubber in such a range, a color material layer satisfying the aforementioned physical properties of the laminate such as tensile yield strength and tensile stress, having superior flexibility and elasticity, and consisting of a strong coated film can be obtained.

Further, when a vinyl chloride/vinyl acetate copolymer is used as the vinyl chloride type resin, and an acrylonitrile/butadiene rubber is used as the rubber type resin, the mixing ratio cannot be generally defined, because it may vary depending on the polymerization ratio of vinyl chloride and vinyl acetate. However, for example, when the polymerization ratio of vinyl chloride and vinyl acetate is in such a range as mentioned above, i.e., 90:10 to 50:50, the weight ratio of vinyl chloride/vinyl acetate copolymer and acrylonitrile/butadiene rubber is preferably about 95:5 to 30:70. With a mixing ratio within such a range, a color material layer 1 satisfying the aforementioned physical properties of the laminate such as tensile yield strength and tensile stress, having superior flexibility and elasticity, and consisting of a strong coated film can be obtained.

When a rubber type resin is used as the synthetic resin constituting the color material layer 1, a rubber type resin containing nitrocellulose is preferred. By using a mixture of nitrocellulose and any one or more of the aforementioned rubber type resins, a color material layer 1 satisfying the aforementioned physical properties of the laminate such as tensile yield strength and tensile stress, and having superior flexibility can be obtained, and the decorating member 5 that can fallow a three-dimensional shape such as a three-dimensionally curved surface can be obtained.

The nitrocellulose is used in order to improve the mechanical strength of the color material layer 1. Although the properties of nitrocellulose change with nitrogen content and solution viscosity (degree of polymerization), values of these items are not particularly limited in the present invention. However, the nitrogen content is preferably 10.5% or higher as for the lower limit, and 12.5% or lower as for the upper limit, from the viewpoint of solubility in a solvent. Moreover, the solution viscosity (JIS K6703:1995) is preferably ⅛ second or more as for the lower limit, and 2 seconds or less as for the upper limit, in view of the handling property.

In a mixture system of nitrocellulose and a rubber type resin, the aforementioned rubber type resins can be used as the rubber type resin, and an ethylene/vinyl acetate rubber and an acrylonitrile/butadiene rubber can be especially preferably used in view of compatibility with nitrocellulose. Although the polymerization ratio of the ethylene and vinyl acetate in the ethylene/vinyl acetate rubber is not particularly limited, it may be about 90:10 to 30:70, preferably about 80:20 to 40:60. With a polymerization ratio within such a range, the color material layer 1 exhibiting superior flexibility can be obtained, and the decorating member 5 that can follow a three-dimensional shape such as a three-dimensionally curved surface can be obtained.

The mixing ratio of the nitrocellulose and the rubber type resin cannot be generally defined because it may vary depending on the type of the rubber type resin. However, for example, when the aforementioned ethylene/vinyl acetate rubber (polymerization ratio of ethylene and vinyl acetate is 90:10 to 30:70), or acrylonitrile/butadiene rubber is used as the rubber type resin, the weight ratio of nitrocellulose and rubber type resin (ethylene/vinyl acetate rubber or acrylonitrile/butadiene rubber) is preferably about 90:10 to about 10:90. With a mixing ratio within such a range, the color material layer 1 exhibiting superior flexibility and elasticity and showing a high coated film strength can be obtained.

Hereafter, colorants that can be incorporated into the color material layer 1 will be explained. Although the color material layer 1 may not essentially contain a colorant as described above, the color material layer 1 comprises a synthetic resin and a colorant as one embodiment. As the colorant mixed in the synthetic resin constituting the color material layer 1 of such an embodiment, commercially available dyes, pigments, metal flakes, metal pastes, and so forth can be used, and they can be used so that a desired color can be obtained. Examples of the dyes include, for example, disperse dyes, reactive dyes, basic dyes, acid dyes, oil-soluble dyes, naphthol dyes, and so forth, and examples of the pigments include, for example, azo type pigments, phthalocyanine type pigments, quinacridone type pigments, anthraquinone type pigments, dioxazine type pigments, ultramarine blue, and so forth. Further, in order to obtain metallic feeling, stainless steel flakes, nickel flakes, aluminum alloy flakes, magnetic flakes such as those of ferrosilicon, nickel paste, aluminum paste, and so forth can be used as the metal flakes or metal pastes.

The content of the colorant in the color material layer 1 is not particularly limited, and the colorant may be used at a content appropriately adjusted depending on the type of colorant to be used, desired color, and so forth. For example, when metal flakes or metal pastes are used for models of automobiles etc. in order to obtain a metallic feeling, the content in the color material layer 1 is about 0.1 to 200% by weight, preferably about 5 to 100% by weight.

The color material layer 1 may contain additives such as other pigments, release agents, ultraviolet absorbers, antistatic agents, flame retardants, antifungal agents, anti-corrosive agents, light stabilizers, anti-oxidants, plasticizers, leveling agents, flow regulators, antifoaming agents and dispersing agents, within such a range that achievement of the object of the present invention should not be inhibited.

The thickness of the color material layer 1 is not particularly limited, since it may vary depending on size of a portion of an object of decoration on which the laminate is adhered. However, it may be about 1 to 200 μm, preferably about 5 to 100 μm. With a thickness of 1 μm or larger, the laminate can follow a three-dimensionally curved surface and can be adhered on it without fracture, when it is adhered on an object of decoration. Further, when the laminate has the re-peelable property, the laminate comprising the color material layer 1 having a thickness of 5 μm or larger can be peeled from an object of decoration without fracture. By using the color material layer having a thickness of 200 μm or smaller, it can be made easier to follow a three-dimensional shape such as a three-dimensionally curved surface.

Hereafter, the adhesive layer 2 will be explained. The adhesive layer 2 is formed from at least an adhesive component. The adhesive component is not particularly limited, and natural resin type adhesives, synthetic resin type adhesives and so forth are used. Synthetic resin type adhesives such as acrylic type adhesives, silicone type adhesives and urethane type adhesives are preferably used. Among these, crosslinking type adhesives are preferred, since they have weather resistance and are unlikely to cause cohesive failure, adhesion power thereof can be easily controlled, and re-peelable property and re-adherable property thereof can be controlled. Acrylic type adhesives of crosslinking type are especially preferably used in view of ease of handling thereof. The crosslinking agent used for the adhesive layer is not particularly limited, and for example, isocyanate type crosslinking agents, epoxy type crosslinking agents, imine type crosslinking agents, metal chelates, and so forth can be used.

The thickness of the adhesive layer 2 is not particularly limited. However, when the adhesion area is small, a smaller thickness is more preferred in view of fineness of the finished article, and when the adhesion area is large, a thickness large to a certain extent is preferred so that it can follow a three-dimensionally curved surface and be continuously adhered. Therefore, although the thickness of the adhesive layer can be suitably chosen depending on the size of adhesion area and cannot be generally defined, it is preferably about 1 to 100 μm, more preferably about 10 to 30 μm.

The adhesive layer 2 may contain, besides the adhesive component and crosslinking agent, pigments showing superior concealing property, or additives such as other pigments, dyes, colorants, antistatic agents, flame retardants, antifungal agents, anti-corrosive agents, ultraviolet absorbers, light stabilizers, anti-oxidants, plasticizers, leveling agents, flow regulators, antifoaming agents and dispersing agents. However, addition amounts of these additives are desirably in such a range that the functions of the adhesive layer should not be degraded.

The adhesive layer 2 can be formed by applying a coating solution containing the aforementioned adhesive component and crosslinking agent as well as other additives. However, so long as the physical properties of the laminate of the present invention are not degraded, it is also possible to use a commercially available double-sided tape or the like.

The decorating member of the present invention comprises the substrates 31 and 32 and the laminate 4 consisting of the color material layer 1 and the adhesive layer 2, which are explained above, as fundamental elements. However, it is also possible to provide various layers between the laminate 4 and the substrates 31 and 32 as required so long as the physical properties of the laminate 4 are not degraded.

For example, in the decorating member of the present invention, an anti-blocking layer may be provided between the color material layer 1 and the peelable substrate 31 contacting with the color material layer 1, or as for the decorating member of the structure of FIG. 3, on the color material layer 1.

The anti-blocking layer is a layer for preventing blocking of the laminate 4 (color material layer 1), which is caused when it contacts with other substances. By providing the anti-blocking layer, it becomes possible to, for example, stack the decorating members 5 not having the substrate 31 or after peeling of the substrate 31, or wind the decorating member 5 in the form of roll. Moreover, even when the surfaces of the laminates 4 are contacted, or color material layers of other decorating members etc. are contacted, they are not adhered, and thus lowering of workability in adhesion to objects of decoration can be prevented.

The anti-blocking layer may be one having fine convexes and concaves on the surface like the conventional anti-blocking layers. However, when a transparent synthetic resin layer is used as at least the uppermost layer of the color material layer in order to impart gloss to an object of decoration, a highly glossy layer is preferred for maintaining the gloss. Specifically, it preferably has a specular gloss of 110% or more, more preferably 120% or more, for an incidence angle of 60°, according to JIS K5600-4-7:1999.

As the material of the anti-blocking layer, known materials can be used. However, as materials that can maintain the gloss mentioned above and prevent blocking, for example, cellulose type resins such as cellulose acetate, cellulose acetate butyrate, cellulose acetate propionate, carboxymethylcellulose, nitrocellulose, cellulose propionate and ethylcellulose can be mentioned. Among these, ethylcellulose, cellulose acetate butyrate and cellulose acetate propionate are especially preferably used in view of solubility in a solvent.

If such a layer utilizing a cellulose type resin is provided between the peelable substrate 31 consisting of a plastic film such as that of polyester, polypropylene or polyethylene and the color material layer 1 in the decorating member comprising the color material layer 1 and the peelable substrate 31 provided thereon, it shows favorable peelable property for peeling from the substrate 31. Therefore, it not only prevents blocking of the color material layer 1, but also functions as a layer improving the peelable property. In particular, when the color material layer 1 consists of a mixture system of nitrocellulose and a rubber type resin, it also shows favorable adhesion with the color material layer 1, and can provides functions of improving the peelable property, preventing blocking, maintaining gloss and so forth as the uppermost layer of the laminate. Furthermore, since such a layer favorably accepts a solvent type ink of an inkjet printer, desired patterns can be printed on the color material layer 1 after the peelable substrate 31 is peeled from the decorating member 5 comprising such an anti-blocking layer.

Such an anti-blocking layer or a layer comprising a cellulose type resin can be obtained by preparing a coating solution for anti-blocking layer by mixing the aforementioned synthetic resin and various additives similar to those mentioned for the color material layer 1 with a dilution solvent, adjusting the composition of the solution, applying the solution on the substrate 31 by any one of conventionally known coating methods such as those mentioned for the formation of the color material layer 1, and drying the coated solution.

Although the thickness of the anti-blocking layer or layer comprising a cellulose type resin is not particularly limited, it is preferably about 0.01 to 2 μm, more preferably about 0.1 to 1 μm. By using the anti-blocking layer or layer comprising a cellulose type resin having a thickness of 0.01 μm or larger, sufficient anti-blocking property can be obtained, and favorable release property can be obtained for release from the peelable substrate 31. Moreover, by using the anti-blocking layer or layer comprising a cellulose type resin having a thickness of 2 μm or smaller, favorable adhesion property of the decorating member for adhesion to an object of decoration having a three-dimensional shape such as a three-dimensionally curved surface can be obtained without inhibiting elongation of the color material layer 1.

In the decorating member of the present invention, besides the aforementioned anti-blocking layer or layer comprising a cellulose type resin, functional layers such as concealing layer and antistatic layer may be provided in order to impart various performances such as improvement of concealing property, and impartation of antistatic property. Such functional layers can be obtained by preparing a coating solution for each functional layer by mixing a synthetic resin, which may be selected from those similar to those mentioned for the color material layer 1, and various additives suitable for the purpose with a dilution solvent, adjusting the composition of the solution, applying the solution on the color material layer by any one of conventionally known coating methods such as those mentioned for the formation of the color material layer, and drying the coated solution.

Hereafter, the method for producing the decorating member of the present invention will be explained. Although the method for producing the decorating member of the present invention is not particularly limited, each layer constituting the decorating member can be formed by applying a coating solution on a substrate or a layer formed on a substrate, and drying the coated solution. Exemplary production methods are illustrated in FIGS. 4 and 5.

In order to produce the decorating member 5 shown in FIG. 1, a coating solution for color material layer is first prepared by mixing a synthetic resin and a colorant constituting the color material layer 1 as well as additives added as required with a dilution solvent, the composition of the solution is adjusted, then this coating solution is applied on the aforementioned peelable substrate 31 by a conventionally known coating method such as those utilizing bar coater, die coater, blade coater, spin coater, roll coater, gravure coater, curtain coater, spray and screen printing, and the coated solution is dried and cured by heating to prepare the color material layer 1 on the substrate 31, as shown in FIG. 4 (a).

When the color material layer 1 comprises multiple layers, for example, a transparent layer and a printing layer or a transparent layer and an ink receiving layer, or when an anti-blocking layer or the like is provided between the color material layer 1 and the substrate 31, coating solutions for the layers can be successively applied on the substrate 31, dried and cured by heating to obtain the color material layer 1 having a multi-layer structure.

Then, a coating solution for adhesive layer is prepared by dissolving or dispersing an adhesive component and a crosslinking agent constituting the adhesive layer 2 as well as additives added as required in a solvent, applied on the color material layer 1 by a conventionally known coating method such as those mentioned for the formation of the color material layer 1, and dried to form the adhesive layer 2 (FIG. 4 (b)). This adhesive layer 2 can be adhered to the substrate 32 having release property to obtain the decorating member shown in FIG. 1 (FIG. 4 (c)).

Alternatively, the decorating member shown in FIG. 1 can be obtained as shown in FIG. 5 by forming the color material layer 1 on the substrate 31 (FIG. 5 (a)), separately forming the adhesive layer 2 on the peelable substrate 32 (FIG. 5 (b)), and adhering the exposed adhesive layer 2 and the color material layer 1 formed on the substrate 31 (FIG. 5 (c)) . Further, when a commercially available double-sided tape is used as the adhesive layer 2, the decorating member shown in FIG. 1 can be obtained by adhering the aforementioned color material layer to one surface of the double-sided tape and, adhering the substrate having the release property to another surface of the double-sided tape.

Hereafter, the decorating member 5 shown in FIG. 2 will be explained. Also for the decorating member 5 shown in FIG. 2, those used for the decorating member 5 shown in FIG. 1 can be used for the color material layer 1, the adhesive layer 2 and the peelable substrate 31, and it can be prepared by forming the color material layer 1 on the peelable substrate 31 and forming the adhesive layer 2 on the color material layer 1 in the same manner as that used for the decorating member 5 shown in FIG. 1.

When the decorating member having a structure that the peelable substrate 31 is provided on the color material layer 1 as shown in FIG. 2 is prepared, the surface of the substrate 31 opposite to the surface contacting with the color material layer 1 is preferably subjected to a release treatment. By subjecting the surface opposite to the surface contacting with the color material layer 1 to a release treatment as described above, the noise generated by separation of the adhesive layer 2 from the substrate 31 can be suppressed when the rolled decorating member 5 is used, and the decorating member 5 can be used by pulling it with a small force.

Since the decorating member 5 shown in FIG. 2 does not use the substrate 32 which is ultimately thrown away unlike the decorating member 5 shown in FIG. 1, it is economical, and it can reduce garbage and thus is an earth environment-friendly product.

Hereafter, the decorating member 5 shown in FIG. 3 will be explained. Also for the decorating member 5 shown in FIG. 3, those used for the decorating member 5 shown in FIG. 1 can be used for the color material layer 1, the adhesive layer 2 and the peelable substrate 32. However, when the structure shown in FIG. 3 is used, the color material layer 1 preferably has a thickness of 5 μm or larger as for the lower limit. By using the layer having a thickness of 5 μm or larger, it can be made easy to delaminate the substrate 32 from the laminate 4 consisting of the color material layer 1 and the adhesive layer 2.

Such a decorating member 5 as shown in FIG. 3 can be produced by, for example, producing a decorating member having the same structure as that of the decorating member shown in FIG. 1 according to the method shown in FIGS. 4 or 5 and then removing the peelable substrate 31 from the color material layer 1.

The decorating members shown in FIGS. 2 and 3 can also be provided with an anti-blocking layer or the like between the substrate 31 and the color material layer 1, or a functional layer such as concealing layer and antistatic layer between the color material layer and the adhesive layer, as required, like the decorating member shown in FIG. 1.

As described above, the decorating member of the present invention comprises a laminate consisting of a color material layer and a adhesive layer and a peelable substrate provided on the color material layer and/or the adhesive layer, wherein the laminate has a tensile yield strength of 1 to 12 MPa according to JIS K7113:1995, and a tensile stress of 13 MPa or lower required for enlongating the laminate to an elongation rate of 100% or more. Thus the decorating member can have superior flexibility that allows the laminate to follow a surface of three-dimensional shape such as a three-dimensionally curved surface. Therefore, it enables easy and fine decoration of a surface of three-dimensional shape such as a three-dimensionally curved surface of toys and models of airplanes, automobiles etc.

### EXAMPLES

Hereafter, the present invention will be further explained in detail with reference to examples. The term and symbol “part” and “%” used in the examples are used on weight basis unless specifically indicated.

### Example 1

On one surface of a polyester film having a thickness of 50 μm (COSMOSHINE E7007, Toyobo Co., Ltd.) as a peelable substrate, coating solutions for color material layer and adhesive layer having the following compositions were successively applied and dried to form a color material layer having a thickness of 20 μm and an adhesive layer having a thickness of 20 μm. Then, the adhesive layer was adhered to a polyester film having a thickness of 25 μm (COSMOSHINE E7007, Toyobo Co., Ltd.) as a peelable substrate to prepare a decorating member of Example 1. The “vinyl chloride/vinyl acetate copolymer (a)” included in the composition was prepared at a polymerization ratio of vinyl chloride:vinyl acetate=87:13 and had a solid content of 100%, and the mixing ratio of the vinyl chloride/vinyl acetate copolymer (a) and the acrylonitrile/butadiene rubber was 70:30.

### Composition of Coating Solution for Color Material Layer of Example 1

| | |
|---|---|
| Vinyl chloride/vinyl acetate copolymer (a) | 14 parts |
| (solid content: 100%, SOLBIN C, | |
| Nissin Chemical Industry Co., Ltd.) | |
| Acrylonitrile/butadiene rubber | 6 parts |
| (solid content: 100%, Nipol DN-306, | |
| Nippon Zeon Co., Ltd.) | |
| Colorant (aluminum paste, | 20 parts |
| solid content: 71%, Aluminum Paste 610N, | |
| SHOWA ALUMINUM POWDER K.K.)) | |
| Methyl ethyl ketone | 40 parts |
| Toluene | 40 pairs |

### Coating Solution for Adhesive Layer of Example 1

| | |
|---|---|
| Acrylic type adhesive | 68 parts |
| (solid content: 30%, SK-Dyne 1495, | |
| Soken Chemical & Engineering Co., Ltd.) | |
| Isocyanate type crosslinking agent | 0.5 part |
| (solid content: 30%, L-45, | |
| Soken Chemical & Engineering Co., Ltd.) | |
| Ethyl acetate | 16 parts |
| Toluene | 16 pairs |

### Example 2

A decorating member of Example 2 was prepared in the same manner as that used in Example 1 except that 12 parts of a vinyl chloride resin (solid content: 100%, TK-800, Shin-Etsu Chemical Co., Ltd.) was added instead of the vinyl chloride/vinyl acetate copolymer (a), and the addition amount of the acrylonitrile/butadiene rubber was changed to 8 parts in the coating solution for color material layer of Example 1. The mixing ratio of the vinyl chloride resin and the acrylonitrile/butadiene rubber was 60:40.

### Example 3

A decorating member of Example 3 was prepared in the same manner as that used in Example 1 except that 16 parts of a vinyl chloride/vinyl acetate copolymer (b) (polymerization ratio of vinyl chloride:vinyl acetate 75:25, solid content: 100%, SOLBIN C5, Nissin Chemical Industry Co., Ltd.) was added instead of the vinyl chloride/vinyl acetate copolymer (a), and the addition amount of the acrylonitrile/butadiene rubber was changed to 4 parts in the coating solution for color material layer of Example 1. The mixing ratio of the vinyl chloride/vinyl acetate copolymer (b) and the acrylonitrile/butadiene rubber was 80:20.

### Example 4

A decorating member of Example 4 was prepared in the same manner as that used in Example 1 except that a coating solution for color material layer having the following composition was used instead of the coating solution for color material layer of Example 1.

### Composition of Coating Solution for Color Material Layer of Example 4

| | |
|---|---|
| Urethane type resin (solid content: 35%, | 43 parts |
| Neopaint #8500 Clear, | |
| Asia Industry Co., Ltd.) | |
| Isocyanate type crosslinking agent | 9 parts |
| (solid content: 53%, crosslinking agent for | |
| Neopaint #8500, Asia Industry Co., Ltd.) | |
| Colorant (aluminum paste, | 20 parts |
| solid content: 71%, Aluminum Paste 610N, | |
| SHOWA ALUMINUM POWDER K.K.) | |
| Methyl ethyl ketone | 24 parts |
| Toluene | 24 parts |

### Example 5

A decorating member of Example 5 was prepared in the same manner as that used in Example 1 except that a coating solution for adhesive layer having the following composition was used instead of the coating solution for adhesive layer of Example 1.

### Coating Solution for Adhesive Layer of Example 5

| | |
|---|---|
| Acrylic type adhesive | 50 parts |
| (solid content: 40%, SK-Dyne 1502, | |
| Soken Chemical & Engineering Co., Ltd.) | |
| Isocyanate type crosslinking agent | 0.7 part |
| (solid content: 30%, L-45, | |
| Soken Chemical & Engineering Co., Ltd.) | |
| Ethyl acetate | 25 parts |
| Toluene | 25 pairs |

### Comparative Example 1

A decorating member of Comparative Example 1 was prepared in the same manner as that used in Example 1 except that the addition amount of the vinyl chloride resin was changed to 20 parts, and the acrylonitrile/butadiene rubber was not added in the coating solution for color material layer of Example 2.

### Comparative Example 2

A decorating member comprising a color material layer and an adhesive layer provided on one surface of the color material layer (Scotchcal Film JS1802, Sumitomo 3M Ltd.) was used as a decorating member of Comparative Example 2.

### Example 6

A decorating member of Example 6 was prepared in the same manner as that used in Example 1 except that a coating solution for color material layer having the following composition was used instead of the coating solution for color material layer of Example 1. The polymerization ratio of ethylene and vinyl acetate in the ethylene/vinyl acetate rubber included in the composition was 59:41, the solution viscosity of the nitrocellulose was ½ second, and the mixing ratio of the nitrocellulose and the ethylene/vinyl acetate rubber was 40:60.

### Composition of Coating Solution for Color Material Layer of Example 6

| | |
|---|---|
| Nitrocellulose (solid content: 70%, | 20 parts |
| Nitrocellulose RS1/2 (H type), Daicel Chemical | |
| Industries:, Ltd.) | |
| Ethylene/vinyl acetate rubber | 21 parts |
| (solid content: 100%, Sumitate RB-11, | |
| Sumitomo Chemical Co., Ltd.) | |
| Colorant (aluminum paste, | 35 parts |
| solid content: 71%, Aluminum Paste 610N, | |
| SHOWA ALUMINUM POWDER K.K.) | |
| Methyl ethyl ketone | 45 parts |
| Toluene | 45 parts |

### Example 7

A decorating member of Example 7 was prepared in the same manner as that used in Example 1 except that a coating solution for color material layer having the following composition was used instead of the coating solution for color material layer of Example 1. The nitrocellulose used in the coating solution for color material layer of the following composition was the same as that used in Example 6, and the mixing ratio of the nitrocellulose and the acrylonitrile/butadiene rubber was 30:70.

### Composition of Coating Solution for Color Material Layer of Example 7

| | |
|---|---|
| Nitrocellulose (solid content: 70%) | 30 parts |
| Acrylonitrile/butadiene rubber | 49 parts |
| (solid content: 100%, Nipol 1432-J, | |
| Nippon Zeon Co., Ltd.) | |
| Colorant (aluminum paste, | 70 parts |
| solid content: 71%, Aluminum Paste 610N, | |
| SHOWA ALUMINUM POWDER K.K.) | |
| Methyl ethyl ketone | 100 parts |
| Toluene | 100 parts |

### Example 8

On one surface of a polyester film having a thickness of 50 μm (Lumilar T60, Toray Industries, Inc.) as a peelable substrate, coating solutions for anti-blocking layer and color material layer having the following compositions, the coating solution for color material layer of Example 6, and the coating solution for adhesive layer of Example 6 were successively applied and dried to form an anti-blocking layer having a thickness of 0.5 μm, a transparent color material layer having a thickness of 20 μm, a color material layer having a thickness of 10 μm and an adhesive layer having a thickness of 20 μm. Then, the adhesive layer was adhered to a polyester film having a thickness of 25 μm similar to that used in Example 6 to prepare a decorating member of Example 8. The nitrocellulose and ethylene/vinyl acetate rubber used in the coating solution for color material layer having the following composition were the same as those used in Example 6, and the mixing ratio of the nitrocellulose and ethylene/vinyl acetate rubber was also the same as that used in Example 6.

When the polyester film in contact with the blocking layer of the decorating member of Example 8 was peeled, and surface gloss of the anti-blocking layer surface was measured at an incidence angle of 60° according to JIS K5600-4-7:1999 by using a digital deflection glossimeter (UGK-5K, Suga Test Instruments Co., Ltd.), the surface gloss was 130%.

### Composition of Coating Solution for Anti-Blocking Layer

| | |
|---|---|
| Cellulose acetate propionate | 2 parts |
| (solid content: 100%, CAP482-0.5, | |
| KODAK Inc.) | |
| Ethyl acetate | 9 parts |
| Methyl ethyl ketone | 9 parts |

### Composition of Coating Solution for Color Material Layer of Example 8

| | |
|---|---|
| Nitrocellulose (solid content: 70%) | 20 parts |
| Ethylene/vinyl acetate rubber | 21 parts |
| (solid content: 100%) | |
| Methyl ethyl ketone | 45 parts |
| Toluene | 45 parts |

Tensile yield strength, tensile stress for obtaining an elongation rate of 100%, elongation rate obtained with a tensile stress of 13 MPa and adhesive power of the laminates of the decorating members of the examples and the comparative examples were measured. Further, adhesion property for adhesion to a three-dimensionally curved surface, re-peelable property, and re-adherable property thereof were evaluated. The results are shown in Table 1.

(1) Measurement of Tensile Yield Strength, Tensile Stress at Elongation Rate of 100% and Elongation Rate at Tensile Stress of 13 MPa

The peelable substrates of the decorating members of the examples and the comparative examples were peeled, and the laminates comprising the color material layer and the adhesive layer were left under an environment of 23° C. and 50% RH for 48 hours. Then, tensile yield strength, tensile stress for obtaining an elongation rate of 100%, and elongation rate obtained with a tensile stress of 13 MPa of the laminates were measured according to JIS K7113:1995 by using a Tensilon universal tensile tester (Tensilon HTM-100, ORIENTEC Co., Ltd.). The test piece was No. 1 type test piece, gauge length was 50 mm, width was 10 mm, and pulling rate was velocity F (50 mm/min±10%).

(2) Measurement of Adhesive Power

The peelable substrates of the decorating members of the examples and the comparative examples were peeled, and 180° peel adhesion of the laminates comprising the color material layer and the adhesive layer was measured according to JIS Z0237:2000 by using a Tensilon universal tensile tester (Tensilon HTM-100, ORIENTEC Co., Ltd.).

(3) Evaluation of Adhesion Property for Adhesion to Three-Dimensionally Curved Surface

The peelable substrates of the decorating members of the examples and the comparative examples were peeled, and the laminates comprising the color material layer and the adhesive layer were adhered on a portion having a three-dimensionally curved surface of a toy consisting of a melamine resin as an object of decoration, and evaluated. When the laminate could follow the shape of the object of decoration and could be finely adhered without generating wrinkles or lifting, the evaluation was represented with “◯”, when the laminate could be adhered although wrinkles or lifting was generated, the evaluation was represented with “Δ”, and when the laminate did not follow the shape of the object of decoration and delaminated after adhesion, the evaluation was represented with “×”.

(4) Evaluation of Re-Peelable Property

The laminates of Examples 1 to 4 adhered in (3) were peeled. When the peeling was easy, the evaluation was represented with “◯”, and when the laminate was likely to be elongated at the time of peeling, and thus peeling was slightly difficult, the evaluation was represented with

(5) Evaluation of Re-Adherable Property

The laminates of Examples 1 to 4 peeled in (4) were re-adhered in the same manner as that used in (3), and evaluated. The evaluation criteria were the same as those used in (3).

TABLE 1

| | Tensile | Tensile | Elongation | | | | |
|---|---|---|---|---|---|---|---|
| | Yield | Stress (MPa) | Rate (%) | Adhesive | Adhesion | Re- | Re- |
| | Strength | (Elongation | (Tensile Stress | Power | To 3D curved | peelable | adherable |
| | (MPa) | Rate of 100%) | of 13 MPa) | (N/10 mm) | surface | property | property |
| Example 1 | 7.5 | 9.2 | 200 or more | 0.38 | ◯ | ◯ | ◯ |
| Example 2 | 8.2 | 9.6 | 200 or more | 0.38 | ◯ | ◯ | ◯ |
| Example 3 | 8.5 | 9.8 | 200 or more | 0.38 | ◯ | ◯ | ◯ |
| Example 4 | 3.1 | 6.0 | 200 or more | 0.38 | ◯ | Δ | ◯ |
| Example 5 | 7.5 | 9.2 | 200 or more | 5.79 | ◯ | — | — |
| Comparative | 20 or | Not | 4 or less | 0.38 | X | — | — |
| Example 1 | more | measurable | | | | | |
| Comparative | 11.3 | 14.0 | 63.3 | 7.87 | Δ | — | — |
| Example 2 | | | | | | | |
| Example 6 | 10.8 | 10.0 | 200 or more | 0.38 | ◯ | ◯ | ◯ |
| Example 7 | 6.1 | 4.6 | 200 or more | 0.38 | ◯ | ◯ | ◯ |
| Example 8 | 6.5 | 4.8 | 200 or more | 0.38 | ◯ | ◯ | ◯ |

As clearly seen from the results shown in Table 1, the decorating members of Examples 1 to 8 showed a tensile yield strength of within the range of 1 to 12 MPa for the laminates consisting of the color material layer and the adhesive layer, and required a tensile stress less than 13 MPa for obtaining an elongation rate of 100% or higher for the laminate, and therefore they showed superior adhesion property for adhesion to the three-dimensionally curved surface. Although the decorating member of Example 8 contained an anti-blocking layer on the color material layer, the thickness thereof was as small as 0.5 μm, therefore it did not affect the color material layer, and thus the laminate exhibited superior adhesion property for adhesion to the three-dimensionally curved surface, like those of Examples 1 to 7.

Since the adhesion layers used in Examples 1 to 4 and 6 to 8 had the re-peelable property, the laminates could be easily peeled from the object of decoration. Further, since the adhesion layers used in Examples 1 to 4 and 6 to 8 also had the re-adherable property, the laminates could be easily adhered again to the object of decoration after the peeling, and thus exhibited superior workability and economies. In particular, the color material layers of the decorating members of Examples 1 to 3 were incorporated with the vinyl chloride type resin and the acrylonitrile rubber at a specific mixing ratio, and the color material layers of the decorating members of Examples 6 to 8 were incorporated with the rubber type resin and the nitrocellulose at a specific mixing ratio, they became tough coated films showing superior elasticity, and the laminates could be most easily peeled.

The adhesive layer used in Example 5 was a layer of strong adhesion type, and did not have re-peelable property. Therefore, it semipermanently provided decoration without delamination.

On the other hand, the laminate of Comparative Example 1 showed a tensile yield strength higher than 20 MPa and an elongation rate of the laminate less than 100%, the laminate could not follow the shape of the object of decoration at all, and peeled after the adhesion, and thus it exhibited inferior adhesion property compared with those of the examples.

The laminate of Comparative Example 2 showed a tensile yield strength of 11.3 MPa, but it required a tensile stress higher than 13 MPa for obtaining an elongation rate of 100% or higher for the laminate. Therefore, it required a strong force to make it follow the three-dimensionally curved surface when it was adhered on it, thus showed bad workability, and generated wrinkles and lifting at some positions. Thus, it exhibited inferior adhesion property compared with those of the examples.

Further, the peelable substrate of the decorating member of Example 8 on the anti-blocking layer side was peeled, and ten sheets having a size of 2 cm x 5 cm were cut from the laminate, stacked so that the anti-blocking layer should be the upper surface, and put between glass plates. A weight of 2.1 kg was placed thereon, and the laminates were left in an environment of 60° C. for 72 hours. As a result, they did not cause blocking at all. Further, the sheets were stacked so that the anti-blocking layer should contact with each other and the polyester films on the adhesive layer side should contact with each other, put between the glass plates, and left in the same manner as described above. As a result, they did not cause blocking at all. Furthermore, the peelable substrate of the decorating member of Example 6 on the color material layer side was peeled, and superimposed on the decorating member of Example 8 of which peelable substrate was peeled so that the color material layer surface of the former should contact with the anti-blocking layer surface of the latter, and they were put between the glass plates, and left in the same manner as described above. As a result, they did not cause blocking at all. As described above, the decorating member of Example 8 could prevent blocking, while maintaining surface gloss.

Further, in order to impart a pattern to the decorating members of Examples 1, 4, 6 to 8 and Comparative Examples 1 and 2, their peelable substrates on the color material layer side were peeled, and the pattern was printed on the color material layer or the anti-blocking layer by using an inkjet printer (JV3, MIMAKI ENGINEERING CO., LTD.). As a result, the pattern could be finely printed on the layers of the decorating members of Examples 1, 6 to 8 and Comparative Examples 1 and 2 without blurring, and they could be made into decorating members having a desired pattern.

### BRIEF DESCRIPTION OF THE DRAWINGS

FIG. 1 A sectional view showing one embodiment of the decorating member of the present invention.

FIG. 2 A sectional view showing another embodiment of the decorating member of the present invention.

FIG. 3 A sectional view showing another embodiment of the decorating member of the present invention.

FIG. 4 A drawing showing an example of the method for producing the decorating member of the present invention.

FIG. 5 A drawing showing another example of the method for producing the decorating member of the present invention.

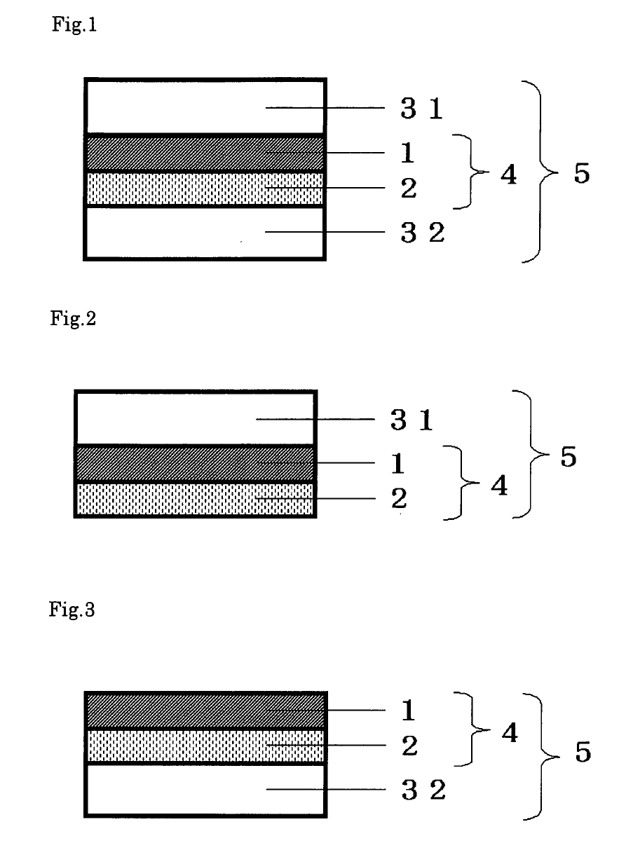

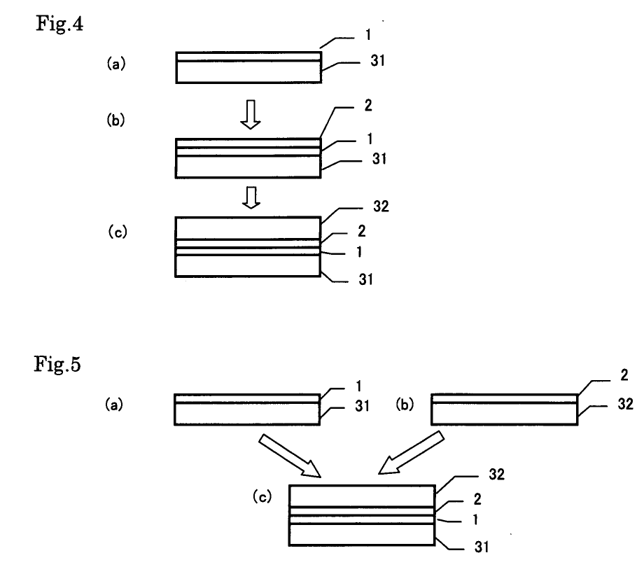

### Description of Notations

1 . . . color material layer, 2 . . . adhesive layers, 31 and 32 . . . peelable substrates, 4 . . . laminate, 5 . . . decorating member

1. A decorating member comprising a laminate consisting of a color material layer and an adhesive layer, and a peelable substrate provided on the color material layer and/or the adhesive layer, wherein the laminate has a tensile yield strength of 1 to 12 MPa according to JIS K7113:1995, and a tensile stress of 13 MPa or lower required for elongating the laminate to an elongation rate of 100% or more.

2. The decorating member according to claim 1, wherein the laminate has re-peelable property for peeling from an object of decoration.

3. The decorating member according to claim 2, wherein the laminate has re-adherable property for adhesion to an object of decoration.

4. The decorating member according to claim 2, wherein the laminate has a 180° peel adhesion of 0.01 to 4 N/10 mm according to JIS Z0237:2000.

5. The decorating member according to claim 1, wherein the color material layer comprises a vinyl chloride type resin.

6. The decorating member according to claim 5, wherein the vinyl chloride type resin is a vinyl chloride/vinyl acetate copolymer.

7. The decorating member according to claim 5, wherein the color material layer comprises a rubber type resin.

8. The decorating member according to claim 1, wherein the color material layer comprises nitrocellulose and a rubber type resin.

9. The decorating member according to claim 8, wherein the rubber type resin is an ethylene/vinyl acetate rubber, or an acrylonitrile/butadiene rubber.

10. The decorating member according to claim 1, wherein the laminate has an anti-blocking layer contacting with the color material layer.

11. The decorating member according to claim 10, wherein the anti-blocking layer comprises a cellulose type resin.

12. The decorating member according to claim 10, wherein surface of the anti-blocking layer has a specular gloss (at incidence angle of 60°) of 110% or higher according to JIS K5600-4-7:1999.

13. The decorating member according to claim 1, which comprises a layer containing a cellulose type resin between the color material layer and the substrate.

14. The decorating member according to claim 3, wherein the laminate has a 180° peel adhesion of 0.01 to 4 N/10 mm according to JIS Z0237:2000.

15. The decorating member according to claim 2, wherein the color material layer comprises a vinyl chloride type resin.

16. The decorating member according to claim 3, wherein the color material layer comprises a vinyl chloride type resin.

17. The decorating member according to claim 4, wherein the color material layer comprises a vinyl chloride type resin.

18. The decorating member according to claim 2, wherein the color material layer comprises nitrocellulose and a rubber type resin.

19. The decorating member according to claim 3, wherein the color material layer comprises nitrocellulose and a rubber type resin.

20. The decorating member according to claim 4, wherein the color material layer comprises nitrocellulose and a rubber type resin.
